(19) United States
(12) Patent Application Publication
(10) Pub. No.: US 2024/0245939 A1
(43) Pub. Date: Jul. 25, 2024

(54) RESPIRATOR

(71) Applicant: 3M Innovative Properties Company, St. Paul, MN (US)

(72) Inventors: NhatHa T. Nguyen, Woodbury, MN (US); Ronald W. Ausen, St. Paul, MN (US); Silvia G.B. Guttmann, St. Paul, MN (US); Michael C. Martin, Hudson, WI (US); Tien Yi T.H. Whiting, St. Paul, MN (US); Allyson V. Grym, Eagan, MN (US); Jeffrey P. Kalish, Woodbury, MN (US)

(21) Appl. No.: 18/416,086

(22) Filed: Jan. 18, 2024

Related U.S. Application Data
(60) Provisional application No. 63/480,790, filed on Jan. 20, 2023.

(51) Int. Cl. A62B 18/02; A62B 18/08

(52) U.S. Cl. CPC A62B 18/025; A62B 18/084

(57) ABSTRACT

A respirator includes a mask body. The respirator further includes a harness including one or more elastic straps. Each of the one or more elastic straps is joined to the mask body on opposing sides thereof. Each of the one or more elastic straps includes at least one first color scheme and at least one second color scheme. The at least one first color scheme is visibly different from the at least one second color scheme. Each of the one or more elastic straps includes at least about 0.5% to about 99.9% of an elastomeric polyolefin by weight.

### TECHNICAL FIELD

The present disclosure relates generally to a respirator, and in particular, to a harness of a respirator.

### BACKGROUND

Respirators are widely used for respiratory protection by users. Typically, respirators include multiple components, such as, headbands, a nose bar, cover webs, etc., which can be easily manufactured using commodity materials available in the market. Thus, such components may be easily copied and replicated to fabricate counterfeit products. Conventionally, components of the respirator, for example, the headband may not include any distinguishable features that may allow identification of counterfeit headbands from genuine headbands. Thus, an inspector may have to put in increased efforts to identify counterfeit headbands. Moreover, users may not be able to identify a genuine product from counterfeit headbands at the time of purchase. In some examples, usage of respirators made of counterfeit components may not provide a desired level of respiratory protection to users, which may lead to illnesses. Counterfeit components of the respirators may also result in loss of sale revenue, product liability, and litigation, which may not be economical.

### SUMMARY

In a first aspect, the present disclosure provides a respirator. The respirator includes a mask body. The respirator further includes a harness including one or more elastic straps. Each of the one or more elastic straps is joined to the mask body on opposing sides thereof. Each of the one or more elastic straps includes at least one first color scheme and at least one second color scheme. The at least one first color scheme is visibly different from the at least one second color scheme. Each of the one or more elastic straps includes at least about 0.5% to about 99.9% of an elastomeric polyolefin by weight.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1A shows a schematic perspective view of a respirator, in accordance with the present disclosure;

FIG. 1B shows a partial schematic front view of an elastic strap of the respirator of FIG. 1A;

FIG. 1C shows a partial schematic front view of an elastic strap of the respirator of FIG. 1A, in accordance with another embodiment of the present disclosure;

FIG. 2A shows a schematic perspective view of a respirator, in accordance with yet another embodiment of the present disclosure;

FIG. 2B shows a partial schematic front view of an elastic strap of the respirator of FIG. 2A;

FIG. 2C shows a partial schematic front view of an elastic strap of the respirator of FIG. 2A, in accordance with an embodiment of the present disclosure;

FIG. 3A shows a schematic rear view of a respirator, in accordance with another embodiment of the present disclosure;

FIG. 3B shows a partial schematic front view of an elastic strap of the respirator of FIG. 3A;

FIG. 3C shows a partial schematic front view of an elastic strap of the respirator of FIG. 3A, in accordance with yet another embodiment of the present disclosure;

FIG. 3D shows a partial schematic front view of an elastic strap of the respirator of FIG. 3A, in accordance with an embodiment of the present disclosure;

FIG. 4A shows a partial schematic front view of an elastic strap that may be used with the respirators of FIGS. 1A, 2A, and 3A, in accordance with another embodiment of the present disclosure;

FIG. 4B shows a partial schematic front view of an elastic strap that may be used with the respirators of FIGS. 1A, 2A, and 3A, in accordance with yet another embodiment of the present disclosure;

FIG. 5A shows a partial schematic front view of an elastic strap that may be used with the respirators of FIGS. 1A, 2A, and 3A, in accordance with an embodiment of the present disclosure;

FIG. 5B shows a partial schematic front view of an elastic strap that may be used with the respirators of FIGS. 1A, 2A, and 3A, in accordance with another embodiment of the present disclosure;

FIG. 6A shows a partial schematic front view of an elastic strap that may be used with the respirators of FIGS. 1A, 2A, and 3A, in accordance with an embodiment of the present disclosure;

FIG. 6B shows a partial schematic front view of an elastic strap that may be used with the respirators of FIGS. 1A, 2A, and 3A, in accordance with another embodiment of the present disclosure;

FIGS. 7A to 7Y show partial schematic front views of elastic straps that may be used with the respirators of FIGS. 1A, 2A, and 3A, in accordance with various embodiments of the present disclosure;

FIGS. 8A to 8Y show partial schematic front views of elastic straps that may be used with the respirators of FIGS. 1A, 2A, and 3A, in accordance with various embodiments of the present disclosure; and

FIGS. 9A to 9C show partial schematic front views of elastic straps that may be used with the respirators of FIGS. 1A, 2A, and 3A, in accordance with various embodiments of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As recited herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than about 10 weight % of each of the first and second materials.

As used herein, “at least one of A and B” should be understood to mean “only A, only B, or both A and B”.

As used herein, the term “tensile elongation at break”, also known as fracture strain or elongation at break, refers to a ratio between increased length and initial length after breakage of a tested specimen at a controlled temperature. It is related to an ability of a polymeric specimen to resist changes of shape without cracking.

As used herein, the term “harness” means a structure or combination of parts that assists in supporting the mask body on a wearer's face.

As used herein, the term “netting” means an openwork structure where the openings are formed by openings or spaces between ribbons and strands of the netting.

As used herein, the term “polymer” and “plastic” each means a material that mainly includes one or more polymers and that may contain other ingredients as well.

As used herein, the term “strap” means a generally flat elongated structure.

A respirator is a personal protective equipment (PPE) commonly worn by people who work in areas where air may be contaminated with toxic substances, such as, airborne particulates, gases, and vapors. The respirators may serve to protect a user from breathing in contaminants present in surrounding air, thus preserving the user's health. Typically, respirators may be of two main types. A first type of the respirator functions by filtering out chemicals and gases, or airborne particles, from the air breathed by the user. Some examples of the first type of the respirators are gas masks and particulate respirators (such as, N95 masks, N96 masks, N97 masks, N98 masks, and N99 masks, etc.). A second type of the respirator protects users by providing clean and respirable air from another source, such as, an air tank. Some examples of the second type of the respirators are airline respirators and self-contained breathing apparatus (SCBA).

Typically, the respirators includes multiple components, such as, headbands, a nose bar, a cover web, etc. Such components of the respirators may be easily manufactured using commodity materials available in the market. Thus, various components of the respirators may be easy to copy and/or replicate to fabricate counterfeit products. Conventionally, the components of the respirators, for example, the headband may not include any distinguishable feature that may allow easy differentiation of genuine headbands from counterfeit headbands. To identify counterfeit headbands, an experienced inspector may be required. Moreover, inspectors may have to put in additional efforts to identify counterfeit headbands. In some cases, users may not be able to identify a genuine headbands from counterfeit headbands at the time of purchase. In addition, counterfeit components of the respirators may also result in loss of sale revenue, product liability, and litigation, which may not be economical. Further, in some examples, usage of respirators made of counterfeit components may not provide a desired level of respiratory protection to users, which may lead to illnesses.

The present disclosure provides a respirator. The respirator disclosed herein includes a mask body. The respirator further includes a harness including one or more elastic straps. Each of the one or more elastic straps is joined to the mask body on opposing sides thereof. Each of the one or more elastic straps includes at least one first color scheme and at least one second color scheme. The at least one first color scheme is visibly different from the at least one second color scheme. Each of the one or more elastic straps includes at least about 0.5% to about 99.9% of an elastomeric polyolefin by weight.

The respirator of the present disclosure may include anti-counterfeiting features that may allow users to easily identify a counterfeit harness from a genuine product. Specifically, the elastic straps of the respirator may include overt and covert features, such as, the first and second color schemes and/or patterns. The first and second color schemes, and the patterns, may allow easy identification of counterfeit harnesses by a simple visual inspection. Further, color compounds used in the elastic straps may be ingenious and may be easily detected by lab equipment. Thus, such color compounds may also be used to identify counterfeit harnesses. In some aspects of the present disclosure, the elastic strap of the respirator includes a third color scheme to add an additional overt feature that may allow easy identification of counterfeit harnesses. In conclusion, the respirator of the present disclosure may allow prevention of counterfeit and replication of the harness associated with respirators, and may educate users about differences between counterfeit harnesses and genuine harnesses by providing information and identifiable features, such as, the first, second, and third color schemes.

In some examples, the one or more elastic straps may be made of a material that has a reduced odor or may be potentially odorless. Further, the one or more elastic straps described herein may be made of the elastomeric polyolefin. Furthermore, the elastic straps may be disposable and recyclable. The elastic strap described herein may also be environment friendly.

Moreover, the first, second, and third color schemes of the elastic straps described herein may include different patterns and widths that may allow easy differentiation of genuine harnesses from counterfeit harnesses. Further, the elastic straps may include different color combinations that may further reduce counterfeiting of the elastic straps. Moreover, the elastic straps as described herein may reduce vulnerability of supply chain issues and may also prevent loss of sale revenue, product liability, and efforts spent in litigation of counterfeit harnesses. In some examples, the harness disclosed herein may be economical to manufacture as compared to conventional harnesses.

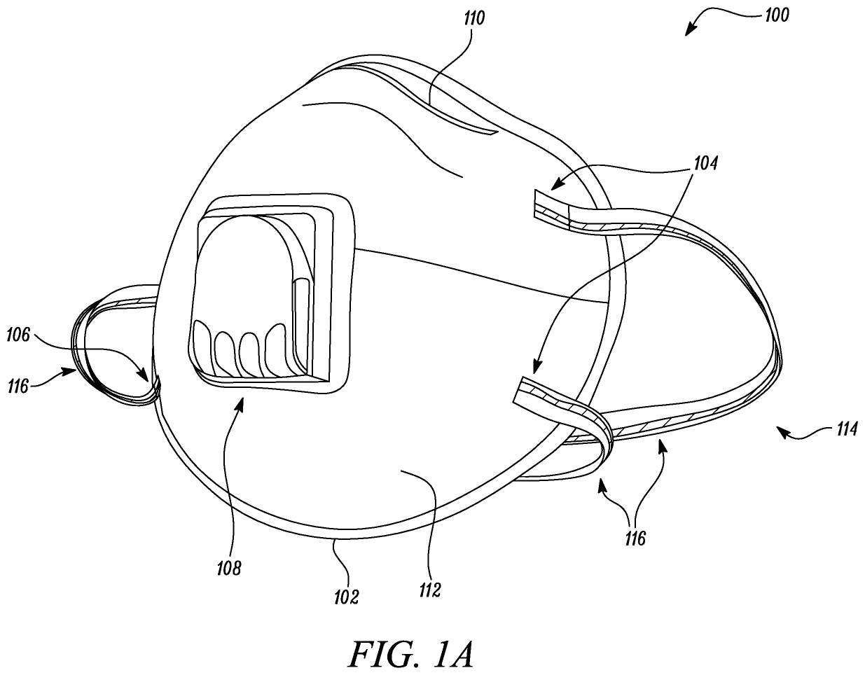

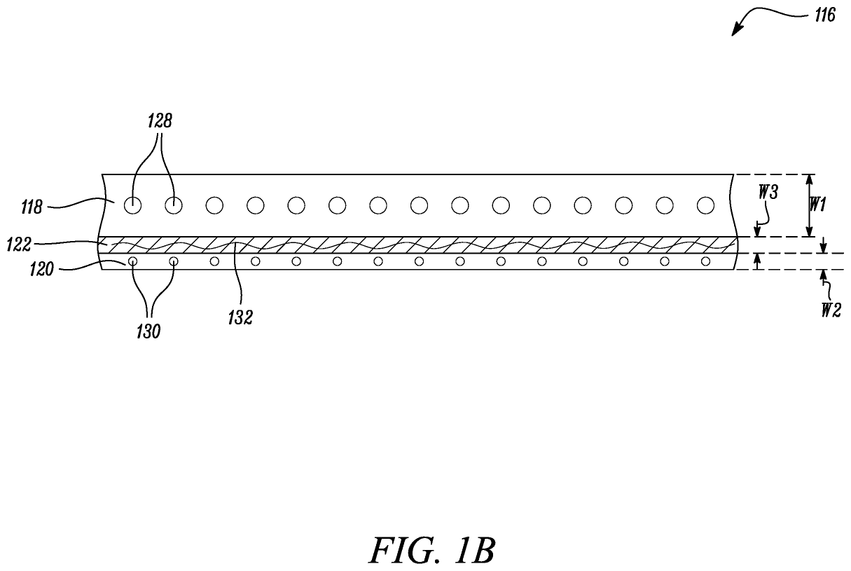

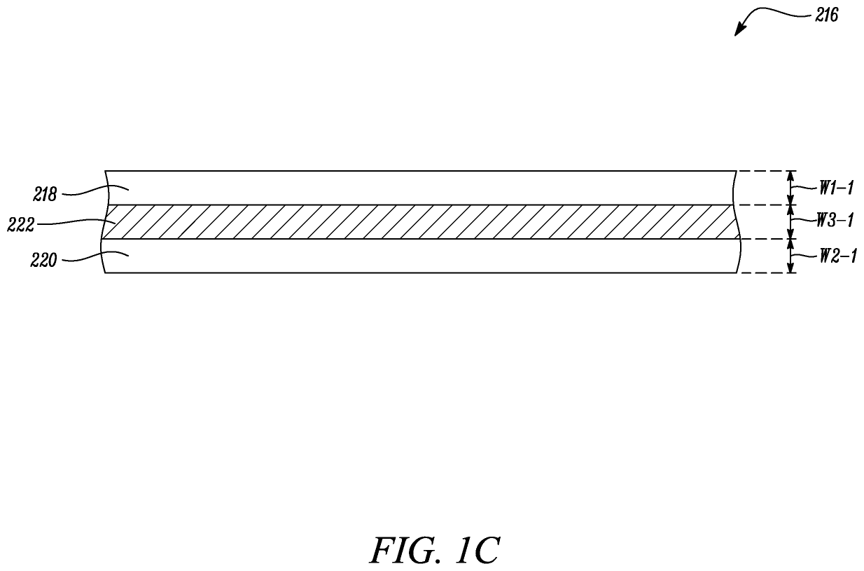

Referring now to figures, FIG. 1A shows a schematic perspective view of a respirator 100 in accordance with an embodiment of the present disclosure. The respirator 100 may be worn by a user (not shown) to provide clean air for the user to breathe. The respirator 100 disclosed herein may be a filtering face mask that covers all or part of a face of the user for protection and/or hygiene.

The respirator 100 includes a mask body 102. The mask body 102 is adapted to fit over the face of the user, such that the mask body 102 covers the nose and the mouth of the user. When the user wears the respirator 100, an interior gas space or void (not shown) is created between the user's face and an interior surface (not shown) of the mask body 102. The mask body 102 may have a curved, hemispherical shape as illustrated in FIG. 1A. However, the mask body 102 may take any appropriate shape or form depending on application. In some examples, the mask body 102 may have a 3-panel design having a foldable configuration such that the respirator 100 may fold flat when not in use but may open into a cup-shaped body when worn. The mask body 102 may be made of a monomer, a polymer, a copolymer, a homopolymer, and combinations thereof, without any limitations. The mask body 102 may include any polymeric material as per design feasibility and application requirement. Further, the mask body 102 may be fabricated using any technique known in the art.

The respirator 100 further includes an exhalation valve 108 attached to the mask body 102 using any suitable technique. The exhalation valve 108 opens in response to increased pressure inside the respirator 100, when the user exhales. The respirator 100 further includes a nose bar 110 that may be attached to a surface 112 of the mask body 102. In some embodiments, the nose bar 110 may be made of a flexible material, such as, a metal or a metal alloy. Some examples of the flexible material used for making the nose bar 110 may include aluminum, aluminum-zinc alloy, galvanized fine iron, galvanized steel, or any other metal or metal alloy. In some embodiments, the nose bar 110 may be made of a flexible non-metallic material. Some examples of the non-metallic material used for making the nose bar 110 may include polymers, such as, polyolefins including polyethylene and polypropylene or any other non-metallic material, as per design feasibility and requirement. However, in some embodiments, the respirator 100 may not include the nose bar 110.

The respirator 100 further includes a harness 114. The harness 114 is attached to the surface 112 of the mask body 102. The mask body 102 and the harness 114 may be connected together by a technique, such as, ultrasonic welding. In other examples, the harness 114 may be attached to the surface 112 of the mask body 102 using a variety of techniques, such as, adhesive bonding, mechanical clamping, a stitch pattern, or a loop. In some embodiments, the harness 114 may also include a head suspension system (not shown). In some embodiments, the head suspension system may support a head of the user.

The harness 114 includes one or more elastic straps 116. In the illustrated embodiment of FIG. 1A, the harness 114 includes two elastic straps 116. It should be noted that the elastic straps 116 are substantially similar to each other in terms of design, material, and functionality. Each elastic strap 116 includes a first side 104 and a second side 106 opposite the first side 104. Each of the one or more elastic straps 116 is joined to the mask body 102 on opposing sides 104, 106 thereof. Specifically, in the illustrated embodiment of FIG. 1A, each of the two elastic straps 116 is joined to the mask body 102 at the first side 104. Further, each of the two elastic straps 116 is joined to the mask body 102 at the second side 106 opposite the first side 104.

In some embodiments, each of the one or more elastic straps 116 is a one-piece extruded component. In some examples, the one or more elastic straps 116 may be manufactured by techniques as described in U.S. Pat. No. 11,033,763, the entire disclosure of which is hereby incorporated by reference herein. However, in other embodiments, the elastic straps 116 may include multiple pieces joined together by any joining techniques known in the art, such as, for example, stitching, ultrasonic welding, adhesive bonding, or mechanical clamping.

In some examples, the elastic straps 116 may be made of materials that may have a reduced odor or may be potentially odorless. Each of the one or more elastic straps 116 may be made of a stretchable material. In some examples, each of the one or more elastic straps 116 made be made from a netting material, such as, a polymeric netting. In other examples, each of the one or more elastic straps 116 made be made from a solid material, that is, the solid material may prevent viewing across the straps 116, partially or totally. Each of the one or more elastic straps 116 includes at least about 0.5% to about 99.9% of an elastomeric polyolefin by weight. In some embodiments, the elastomeric polyolefin is a metallocene elastomer. In some embodiments, each of the one or more elastic straps 116 further includes about 0.1% to about 30% of a styrene butadiene rubber by weight. In an embodiment, each of the one or more elastic straps 116 may include about 5%, about 10%, or about 15% of the styrene butadiene rubber by weight. Alternatively, each of the one or more elastic straps 116 may include a thermal plastic vulcanite instead of styrene butadiene rubber. In some embodiments, each of the one or more elastic straps 116 includes about 0.1% to about 30% of the thermal plastic vulcanite by weight. In other embodiments, each of the one or more elastic straps 116 may include about 5%, about 10%, about 15%, about 20%, about 25%, or about 30% of the styrene butadiene rubber by weight. In some embodiments, each of the one or more elastic straps 116 has a tensile elongation at break of at least 500%. In some embodiments, each of the one or more elastic straps 116 has the tensile elongation at break of at least 700%.

In an embodiment, each of the one or more elastic straps 116 further includes about 2% of a yellow colorant. The yellow colorant may be obtained under the trade designation “PANTONE YELLOW” from Americhem, Cuyahoga Falls, OH. In another embodiment, each of the one or more elastic straps 116 includes a blue colorant instead of the yellow colorant. In an embodiment, each of the one or more elastic straps 116 includes about 2% of the blue colorant. The blue colorant may be commercially available from Clariant, Minneapolis, MN under the product name Solvent Blue 104 or Polysanthren Blue.

In the following examples, the elastomeric polyolefin used was VistaMaxx 7810 obtained from Exxon Mobil, Houston, TX. The thermal plastic vulcanite used was Santoprene 8211 obtained from Celanese, Dallas, TX. The styrene butadiene rubber used was Solprene 1205 obtained from Dynasol Elastomers company, Houston, TX.

In one example, each of the one or more elastic straps 116 includes a first material made of up to 99.9% of the elastomeric polyolefin, about 5% of thermal plastic vulcanite, and about 2% of the yellow colorant. In another example, each of the one or more elastic straps 116 includes a second material made of up to 99.9% of the elastomeric polyolefin, about 10% of thermal plastic vulcanite, and about 2% of the yellow colorant. In yet another example, each of the one or more elastic straps 116 includes a third material made of up to 99.9% of the elastomeric polyolefin, about 20% of thermal plastic vulcanite, and about 2% of the yellow colorant. In one example, each of the one or more elastic straps 116 includes a fourth material made of up to 99.9% of the elastomeric polyolefin, about 20% of thermal plastic vulcanite, and about 2% of the blue colorant. In another example, each of the one or more elastic straps 116 includes a fifth material made of up to 99.9% of the elastomeric polyolefin, about 10% of the styrene butadiene rubber, and about 2% of the yellow colorant.

Table 1 shown below provides results obtained based on experiments performed on each of the first material, the second material, the third material, the fourth material, and the fifth material.

| | Tensile Load | Tensile | | Tensile |
|---|---|---|---|---|
| | at 50% | Load | Maximum | Elongation |
| | Elongation | at 150% | Load | at |
| | in Pounds of | Elongation | Applied | Break in |
| Material | Force (lbf) | in lbf | in lbf | Percentage |
| First | 1.08 | 1.48 | 9 | 717.87 |
| Material | | | | |
| Second | 1.00 | 1.38 | 9.17 | 765.61 |
| Material | | | | |
| Third | 0.94 | 1.39 | 8.2 | 741.09 |
| Material | | | | |
| Fourth | 0.98 | 1.39 | 8.94 | 730.73 |
| Material | | | | |
| Fifth | 0.95 | 1.22 | 7.18 | 760.33 |
| Material | | | | |

FIG. 1B illustrates a partial schematic front view of the elastic strap 116, according to an embodiment of the present disclosure. Only one elastic strap 116 is shown and explained in reference to FIG. 1B. However, the details provided below are equally applicable to each elastic strap 116.

Each of the one or more elastic straps 116 includes at least one first color scheme 118, 120 and at least one second color scheme 122. The at least one first color scheme 118, 120 is visibly different from the at least one second color scheme 122. For the sake of identification, the first color scheme(s) is shown without hatching and the second color scheme(s) is shown with hatching throughout the embodiments of this disclosure.

In some embodiments, the at least one first color scheme 118, 120 includes a pair of first color schemes 118, 120. Furthermore, the pair of first color schemes 118, 120 have different widths W1, W2. Specifically, the first color scheme 118 has a first width W1 and the first color scheme 120 has a second width W2. Further, the first width W1 of the first color scheme 118 is greater than the second width W2 of the first color scheme 120. Alternatively, the first width W1 may be same as the second width W2 or the first width W1 may be lesser than the second width W2. In one example, each of the first color schemes 118, 120 may be blue in color. Alternatively, the first color schemes 118, 120 may have any other color.

Further, in some embodiments, the at least one second color scheme 122 is disposed between the pair of first color schemes 118, 120. The at least one second color scheme 122 includes a single second color scheme herein that is disposed between the pair of first color schemes 118, 120. In addition, the second color scheme 122 has a third width W3. In the illustrated embodiment of FIG. 1B, the third width W3 of the second color scheme 122 is substantially equal to the second width W2 of the first color scheme 120. In another example, the third width W3 may be different from each of the first and second widths W1, W2. In yet another example, the third width W3 may be substantially equal to the first width W1. Further, in one example, the second color scheme 122 may be white in color. Alternatively, the second color scheme 122 may have any other color that is visibly different from the color of the first color schemes 118, 120.

In some embodiments, the first color schemes 118, 120 and the second color schemes 122 have different patterns 128, 130, 132. In other embodiments, the first color schemes 118, 120 and the second color schemes 122 may have a same pattern. In some examples, any one of the first color schemes 118, 120 may have a pattern that is similar to a pattern of the second color scheme 122. In the illustrated embodiment of FIG. 1B, each of the first color schemes 118, 120 has the same pattern 128, 130. Alternatively, each of the first color schemes 118, 120 may have different patterns.

It should be noted that the patterns 128, 130, 132 defined on the first color scheme 118, the first color scheme 120, and the second color scheme 122 may include any of a plurality of horizontal lines, a plurality of vertical lines, a plurality of inclined lines, a plurality of circular or polygonal shapes, a single wave shaped pattern, multiple wave shaped patterns, and the like, without any limitation thereto. Further, the patterns 128, 130, 132 may be defined by continuous lines or discontinuous lines. Furthermore, the patterns 128, 130, 132 may include a raised profile. In the illustrated example of FIG. 1B, each of the patterns 128, 130 includes the plurality of circular shapes and the pattern 132 includes the single wave shaped pattern.

FIG. 1C illustrates a partial schematic front view of an elastic strap 216, according to another embodiment of the present disclosure. The elastic strap 216 may be used with the respirator 100 (see FIG. 1A). The elastic strap 216 may be substantially similar to the elastic strap 116 of FIGS. 1A and 1B, in terms of material composition and functionality. In the illustrated embodiment of FIG. 1C, the second color scheme 222 is disposed between the pair of first color schemes 218, 220. Further, in the illustrated embodiment of FIG. 1C, each of the pair of first color schemes 218, 220 has a same width W1-1, W2-1. In other words, the first width W1-1 is equal to the second width W2-1. Further, in the illustrated embodiment of FIG. 1C, the third width W3-1 of the second color scheme 222 is substantially similar to each of the first width W1-1 and the second width W2-1. In other embodiments, the third width W3-1 may be different from each of the first width W1-1 and the second width W2-1. For example, the third width W3-1 may be greater than or lesser than each of the first width W1-1 and the second width W2-1. It should be noted that details related to patterns and colors of the elastic strap 116 as explained with reference to FIG. 1B is equally applicable to the elastic strap 216 of FIG. 1C.

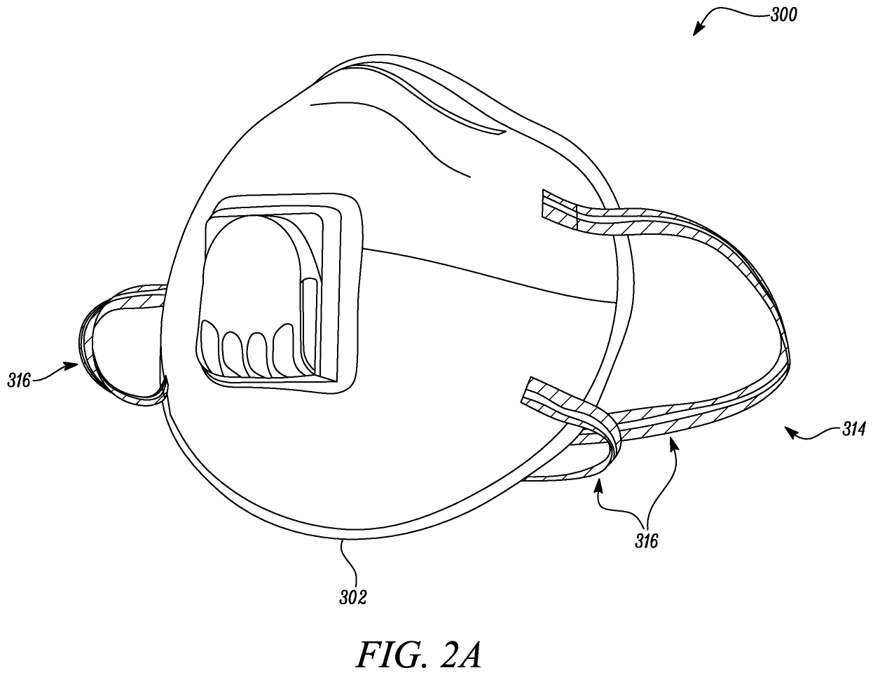

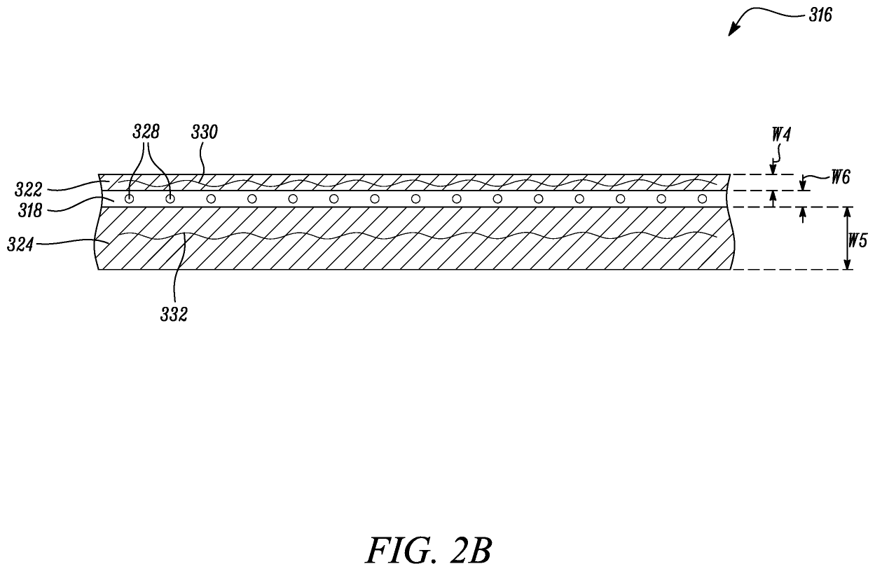

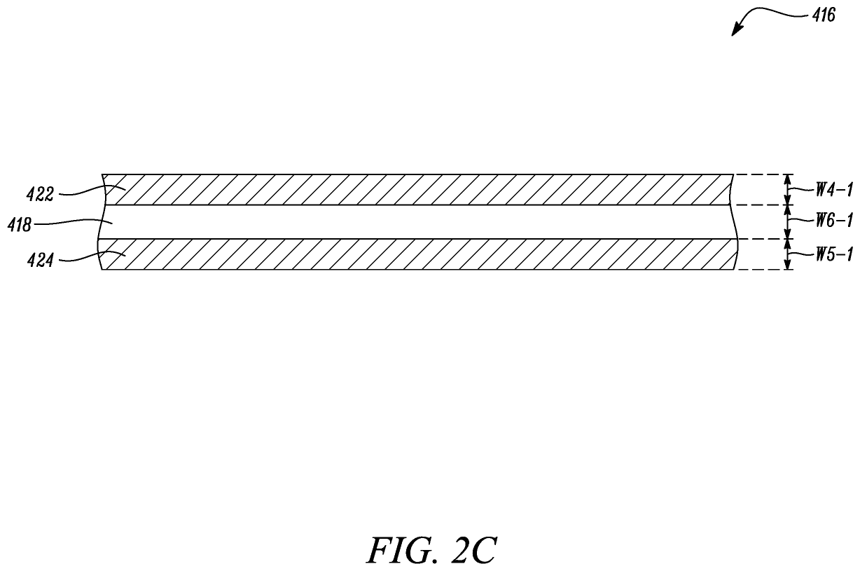

FIG. 2A illustrates a schematic perspective view of a respirator 300, according to another embodiment of the present disclosure. The respirator 300 may be substantially similar to the respirator 100 of FIG. 1A, in terms of material composition, design, and functionality. The respirator 300 includes a mask body 302 and a harness 314. The mask body 302 is substantially similar to the mask body 102 explained in reference to FIG. 1A. In the illustrated embodiment of FIG. 2A, the harness 314 includes a pair of elastic straps 316 that is joined to the mask body 302 of the respirator 300. In some examples, the one or more elastic straps 316 may be used with the respirator 100 (see FIG. 1A).

Referring to FIG. 2B, a partial schematic front view of the elastic strap 316 is illustrated. The elastic strap 316 may be substantially similar to the elastic strap 116 of FIGS. 1A and 1B, in terms of material composition and functionality. The elastic strap 316 includes at least one first color scheme 318 and at least one second color scheme 322, 324. More particularly, in the illustrated embodiment of FIG. 2B, the at least one second color scheme 322, 324 includes a pair of second color schemes 322, 324. Further, in the illustrated embodiment of FIG. 2B, the pair of second color schemes 322, 324 have different widths W4, W5. Specifically, the second color scheme 322 has a first width W4 and the second color scheme 324 has a second width W5. Further, the second width W5 of the second color scheme 324 is greater than the first width W4 of the second color scheme 322. Alternatively, the first width W4 may be same as the second width W5 or the second width W5 may be lesser than the first width W4. In one example, each of the second color schemes 322, 324 may be white in color. Alternatively, each of the second color schemes 322, 324 may have any other color.

Moreover, in some embodiments, the at least one first color scheme 318 is disposed between the pair of second color schemes 322, 324. Further, the at least one first color scheme 318 includes a single first color scheme herein that is disposed between the pair of second color schemes 322, 324. Further, the first color scheme 318 has a third width W6. In the illustrated embodiment of FIG. 2B, the third width W6 of the first color scheme 318 is same as the first width W4 of the second color scheme 322. In another example, the third width W6 may be different from the first width W4. In yet another example, the third width W6 may be same as the second width W5. Further, in one example, the first color scheme 318 may be blue in color. Alternatively, the first color scheme 318 may have any other color that is visibly different from the color of the second color schemes 322, 324.

In some embodiments, the second color schemes 322, 324 and the first color schemes 318 have different patterns 330, 332, 328. In other embodiments, the second color schemes 322, 324 and the first color schemes 318 may have a same pattern. In some examples, any one of the second color schemes 322, 324 may have a pattern that is similar to a pattern of the first color scheme 318. In the illustrated embodiment of FIG. 2B, each of the second color schemes 322, 324 has the same pattern 330, 332. In another example, each of the second color schemes 322, 324 may have different patterns.

It should be noted that the patterns 330, 332, 328 defined on the second color scheme 322, the second color scheme 324, and the first color scheme 318 may include any of a plurality of horizontal lines, a plurality of vertical lines, a plurality of inclined lines, a plurality of circular or polygonal shapes, a single wave shaped pattern, multiple wave shaped patterns, and the like, without any limitation thereto. Further, the patterns 330, 332, 328 may be defined by continuous lines or discontinuous lines. Furthermore, the patterns 330, 332, 328 may include a raised profile. In the illustrated example of FIG. 2B, each of the patterns 330, 332 includes the single wave shaped pattern and the pattern 328 includes the plurality of circular shapes.

FIG. 2C illustrates a partial schematic front view of an elastic strap 416, according to another embodiment of the present disclosure. The elastic strap 416 may be used with the respirator 300 (see FIG. 2A). The elastic strap 416 may be substantially similar to the elastic strap 116 of FIGS. 1A and 1B, in terms of material composition and functionality. In the illustrated embodiment of FIG. 2C, the first color scheme 418 is disposed between the pair of second color schemes 422, 424. Further, in the illustrated embodiment of FIG. 2C, each of the pair of second color schemes 422, 424 has a same width W4-1, W5-1. In other words, the first width W4-1 and the second width W5-1 of the corresponding second color schemes 422, 424 are substantially similar to each other. Further, in the illustrated embodiment of FIG. 2C, the third width W6-1 of the first color scheme 418 is substantially similar to each of the first width W4-1 and the second width W5-1. It should be noted that details related to patterns and colors of the elastic strap 316 as explained with reference to FIG. 2B is equally applicable to the elastic strap 416 of FIG. 2C.

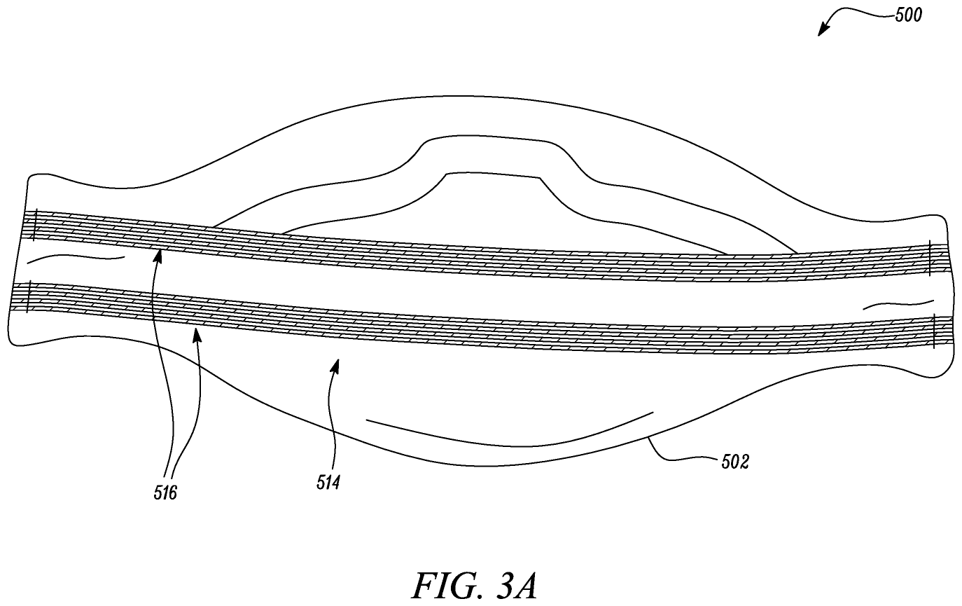

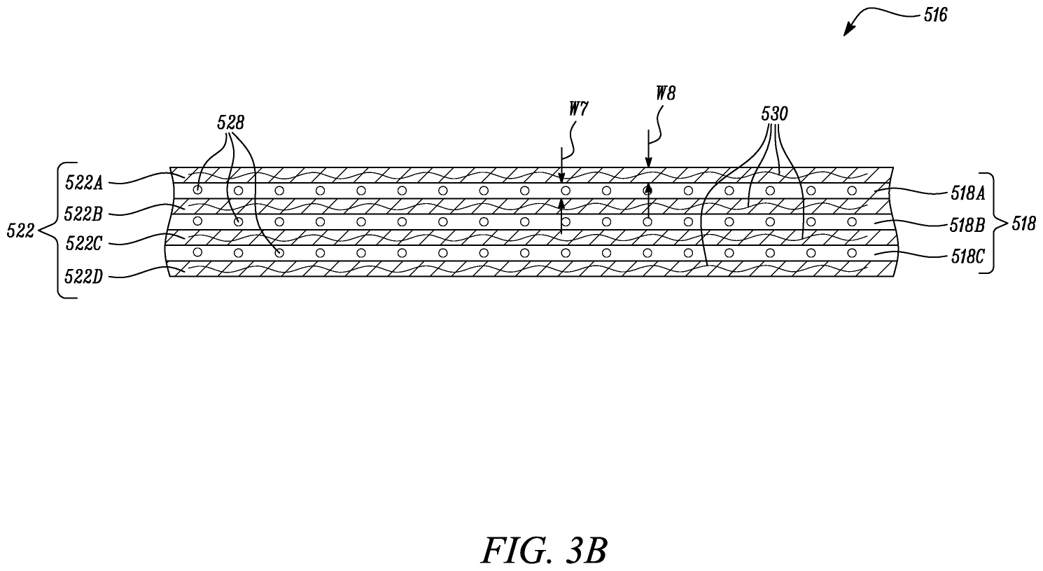

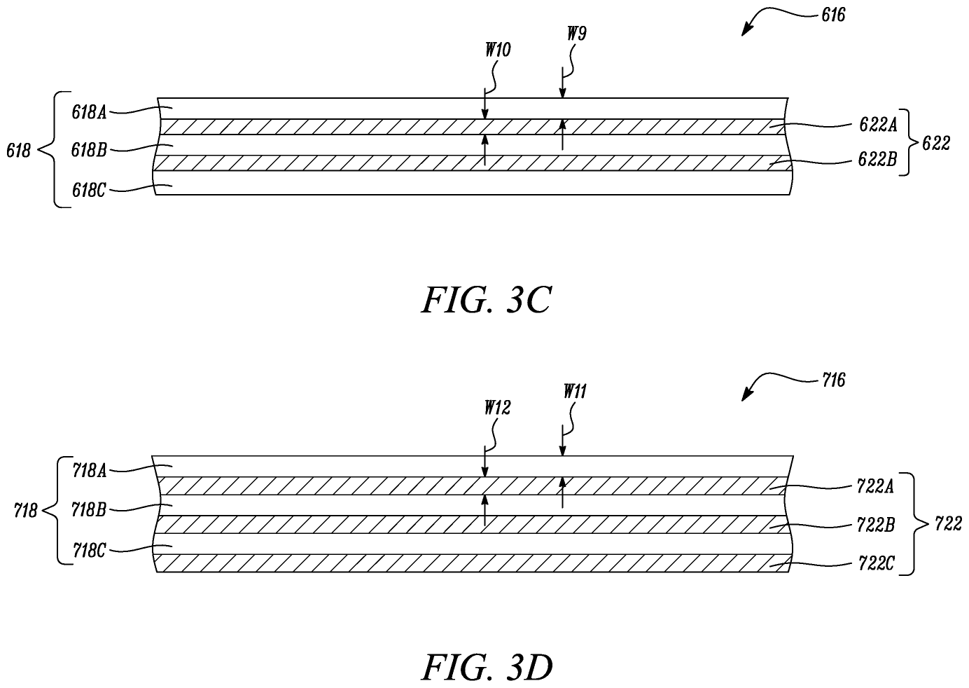

FIG. 3A illustrates a schematic view of a respirator 500, according to yet another embodiment of the present disclosure. The respirator 500 may be substantially similar to the respirator 100 of FIG. 1A, in terms of material composition and functionality. The respirator 500 includes a 3-panel design. In the illustrated embodiment of FIG. 3A, the respirator 500 is disposed in a folded configuration. The respirator 500 further includes a mask body 502 and a harness 514. The harness 514 is attached to the mask body 502. The harness 514 may be attached to the mask body 502 via ultrasonic welding, adhesive bonding, loops, or mechanical clamping. In the illustrated embodiment of FIG. 3A, the harness 514 is attached to the mask body 502 by a stitch pattern.

The harness 514 includes one or more elastic straps 516. In the illustrated embodiment of FIG. 3A, the harness 514 includes two elastic straps 516. It should be noted that the elastic straps 516 are substantially similar to each other in terms of design, material, and functionality. Further, the elastic straps 516 may be substantially similar to the elastic straps 116 described in reference to FIGS. 1A and 1B in terms of material composition and functionality. It should be noted that the elastic straps 516 may also be used with the respirator 100, 300 (see FIGS. 1A and 2A, respectively), without any limitation thereto.

FIG. 3B illustrates a partial schematic front view of the elastic strap 516. The elastic strap 516 has at least one first color scheme 518 and at least one second color scheme 522. The at least one first color scheme 518 includes a plurality of first color schemes 518A, 518B, 518C. Further, the at least one second color scheme 522 includes a plurality of second color schemes 522A, 522B, 522C, 522D alternating with the plurality of first color schemes 518A, 518B, 518C. In other words, the plurality of first color schemes 518A, 518B, 518C and the plurality of second color schemes 522A, 522B, 522C, 522D are arranged in an alternating manner.

In the illustrated embodiment of FIG. 3B, a total number of the first color schemes 518A, 518B, 518C is different from a total number of the second color schemes 522A, 522B, 522C, 522D. More particularly, in the illustrated embodiment of FIG. 3B, the at least one first color scheme 518 includes three first color schemes 518A, 518B, 518C and the at least one second color scheme 522 includes four second color schemes 522A, 522B, 522C, 522D. As illustrated in FIG. 3B, the second color scheme 522A forms a topmost color scheme of the elastic strap 516 whereas the second color scheme 522C forms a lowermost color scheme of the elastic strap 516. Alternatively, the elastic strap 516 may include four first color schemes (similar to the first color schemes 518A, 518B, 518C) and three second color schemes (similar to the second color schemes 522A, 522B, 522C, 522D).

In one example, each of the plurality of first color schemes 518A, 518B, 518C may be blue in color. Alternatively, each of the plurality of first color schemes 518A, 518B, 518C may have any other color. Further, in one example, each of the plurality of second color schemes 522A, 522B, 522C, 522D may be white in color. Alternatively, each of the plurality of second color schemes 522A, 522B, 522C, 522D may have any other color that is visibly different from the color of each of the plurality of first color schemes 518A, 518B, 518C.

Further, each of the plurality of first color schemes 518A, 518B, 518C has a first width W7 and each of the plurality of second color schemes 522A, 522B, 522C, 522D has a second width W8. In the illustrated embodiment of FIG. 3B, the first width W7 of each first color scheme 518A, 518B, 518C is the same. Alternatively, the first width W7 of each first color scheme 518A, 518B, 518C may be different. Moreover, in the illustrated embodiment of FIG. 3B, the second width W8 of each second color scheme 522A, 522B, 522C, 522D is the same. Alternatively, the second width W8 of each second color scheme 522A, 522B, 522C, 522D may be different.

Further, in the illustrated embodiment of FIG. 3B, the first width W7 of each first color scheme 518A, 518B, 518C is same as the second width W8 of each second color scheme 522A, 522B, 522C, 522D. Alternatively, the first width W7 of each first color scheme 518A, 518B, 518C may be different from the second width W8 of each second color scheme 522A, 522B, 522C, 522D.

In some embodiments, each of the plurality of first color schemes 518A, 518B, 518C and each of the plurality of second color schemes 522A, 522B, 522C, 522D have different patterns 528, 530, respectively. In other embodiments, each of the plurality of first color schemes 518A, 518B, 518C and each of the plurality of second color schemes 522A, 522B, 522C, 522D may have a same pattern. It should be noted that the patterns 528, 530 defined on the plurality of first color schemes 516A, 518B, 518C and the plurality of second color schemes 522A, 522B, 522C, 522D may include any of a plurality of horizontal lines, a plurality of vertical lines, a plurality of inclined lines, a plurality of circular or polygonal shapes, a single wave shaped pattern, multiple wave shaped patterns, and the like, without any limitation thereto. Further, the patterns 528, 530, respectively may be defined by continuous lines or discontinuous lines. Furthermore, the patterns 528, 530 may include a raised profile. In the illustrated example of FIG. 3B, each pattern 528 includes the plurality of circular shapes and each pattern 530 includes the single wave shaped pattern.

FIG. 3C illustrates a partial schematic front view of an elastic strap 616, according to yet another embodiment of the present disclosure. The elastic strap 616 may be used with the respirator 100, 300, 500 (see FIGS. 1A, 2A, and 3A, respectively), without any limitation thereto. The elastic strap 616 may be substantially similar to the elastic straps 116 of FIGS. 1A and 1B, in terms of material composition and functionality. In the illustrated embodiment of FIG. 3C, the elastic strap 616 include at least one first color scheme 618 and at least one second color scheme 622.

The at least one first color scheme 618 includes a plurality of first color schemes 618A, 618B, 618C. Further, the at least one second color scheme 622 includes a plurality of second color schemes 622A, 622B alternating with the plurality of first color schemes 618A, 618B, 618C. In other words, the plurality of first color schemes 618A, 618B, 618C and the plurality of second color schemes 622A, 622B are arranged in an alternating manner.

In the illustrated embodiment of FIG. 3C, a total number of the first color schemes 618A, 618B, 618C is different from a total number of the second color schemes 622A, 622B. More particularly, in the illustrated embodiment of FIG. 3C, the at least one first color scheme 618 includes three first color schemes 618A, 618B, 618C and the at least one first second scheme 622 includes two second color schemes 622A, 622B. As illustrated in FIG. 3C, the first color scheme 618A forms a topmost color scheme of the elastic strap 616 whereas the first color scheme 618C forms a lowermost color scheme of the elastic strap 616. Alternatively, the elastic strap 616 may include two first color schemes (similar to the first color schemes 618A, 618B, 618C) and three second color schemes (similar to the second color schemes 622A, 622B).

Further, each of the plurality of first color schemes 618A, 618B, 618C has a first width W9 and each of the plurality of second color schemes 622A, 622B has a second width W10. In the illustrated embodiment of FIG. 3C, the first width W9 of each first color scheme 618A, 618B, 618C is the same. Alternatively, the first width W9 of each first color scheme 618A, 618B, 618C may be different. Moreover, in the illustrated embodiment of FIG. 3C, the second width W10 of each second color scheme 622A, 622B is the same. Alternatively, the second width W10 of each second color scheme 622A, 622B may be different.

Further, in the illustrated embodiment of FIG. 3C, the first width W9 of each first color scheme 618A, 618B, 618C is different from the second width W10 of each second color scheme 622A, 622B. More particularly, the first width W9 is greater than the second width W10. Alternatively, the first width W9 of each first color scheme 618A, 618B, 618C may be same as the second width W10 of each second color scheme 622A, 622B. It should be noted that details related to patterns and colors of the elastic strap 516 as explained with reference to FIG. 3B is equally applicable to the elastic strap 616 of FIG. 3C.

FIG. 3D illustrates a partial schematic front view of an elastic strap 716, according to yet another embodiment of the present disclosure. The elastic strap 716 may be used with the respirator 100, 300, 500 (see FIGS. 1A, 2A, and 3A, respectively), without any limitation thereto. The elastic strap 716 may be substantially similar to the elastic strap 116 of FIGS. 1A and 1B, in terms of material composition and functionality. In the illustrated embodiment of FIG. 3D, the elastic strap 716 include at least one first color scheme 718 and at least one second color scheme 722.

The at least one first color scheme 718 includes a plurality of first color schemes 718A, 718B, 718C. Further, the at least one second color scheme 722 includes a plurality of second color schemes 722A, 722B, 722C alternating with the plurality of first color schemes 718A, 718B, 718C. In other words, the plurality of first color schemes 718A, 718B, 718C and the plurality of second color schemes 722A, 722B, 722C are arranged in an alternating manner.

In the illustrated embodiment of FIG. 3D, a total number of the first color schemes 718A, 718B, 718C is same as a total number of the second color schemes 722A, 722B, 722C. More particularly, in the illustrated embodiment of FIG. 3D, the at least one first color scheme 718 includes three first color schemes 718A, 718B, 718C and the at least one first second scheme 722 includes three second color schemes 722A, 722B, 722C. As illustrated in FIG. 3D, the first color scheme 718A forms a topmost color scheme of the elastic strap 716 whereas the second color scheme 722C forms a lowermost color scheme of the elastic strap 716.

Further, each of the plurality of first color schemes 718A, 718B, 718C has a first width W11 and each of the plurality of second color schemes 722A, 722B, 722C has a second width W12. In the illustrated embodiment of FIG. 3D, the first width W11 of each first color scheme 718A, 718B, 718C is the same. Alternatively, the first width W11 of each first color scheme 718A, 718B, 718C may be different. Moreover, In the illustrated embodiment of FIG. 3D, the second width W12 of each second color scheme 722A, 722B, 722C is the same. Alternatively, the second width W12 of each second color scheme 722A, 722B, 722C may be different.

Further, in the illustrated embodiment of FIG. 3D, the first width W11 of each first color scheme 718A, 718B, 718C is same as the second width W12 of each second color scheme 722A, 722B, 722C. Alternatively, the first width W11 of each first color scheme 718A, 718B, 718C may be different from the second width W12 of each second color scheme 722A, 722B, 722C. It should be noted that details related to patterns and colors of the elastic strap 516 as explained with reference to FIG. 3B is equally applicable to the elastic strap 716 of FIG. 3D.

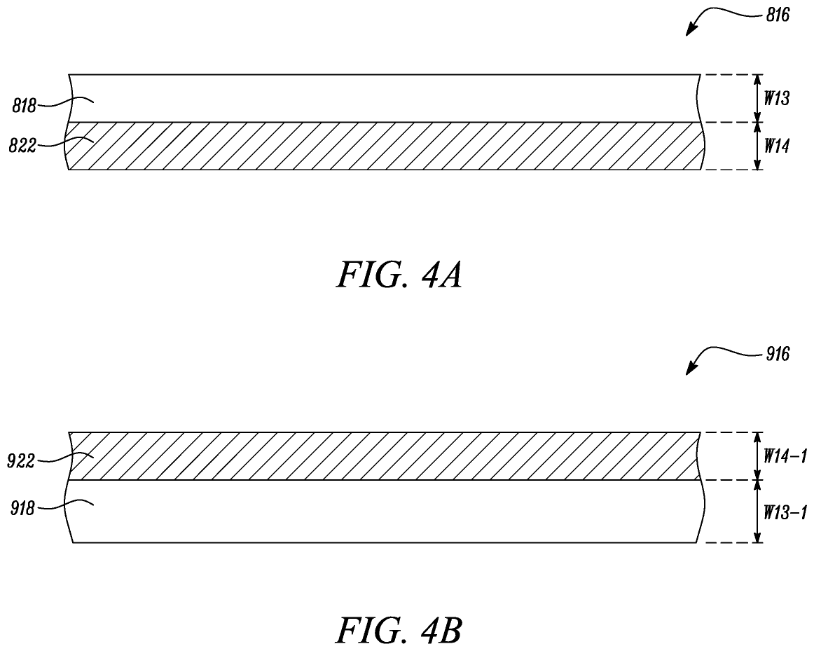

FIG. 4A illustrates a partial schematic front view of an elastic strap 816, according to yet another embodiment of the present disclosure. The elastic strap 816 may be used with the respirator 100, 300, 500 (see FIGS. 1A, 2A, and 3A, respectively). The elastic strap 816 may be substantially similar to the elastic strap 116 of FIGS. 1A and 1B, in terms of material composition and functionality. In the illustrated embodiment of FIG. 4A, the elastic strap 816 includes the first color scheme 818 disposed adjacent to the second color scheme 822. The first color scheme 818 forms a topmost color scheme of the elastic strap 816 and the second color scheme 822 forms a lowermost color scheme of the elastic strap 816. The first color scheme 818 includes a width W13 and the second color scheme 822 includes a width W14. Further, in the illustrated embodiment of FIG. 4A, each of the first color scheme 818 and the second color scheme 822 has the same width W13, W14. Alternatively, the width W13 may be different from the width W14.

FIG. 4B illustrates a partial schematic front view of an elastic strap 916, according to yet another embodiment of the present disclosure. The elastic strap 916 may be used with the respirator 100, 300, 500 (see FIGS. 1A, 3A, and 5A), without any limitation thereto. The elastic strap 916 may be substantially similar to the elastic straps 116 of FIGS. 1A and 1B, in terms of material composition and functionality. In the illustrated embodiment of FIG. 4B, the elastic strap 916 includes the first color scheme 918 disposed adjacent to the second color scheme 922. The first color scheme 918 forms a lowermost color scheme of the elastic strap 916 and the second color scheme 922 forms a topmost color scheme of the elastic strap 916. Further, in the illustrated embodiment of FIG. 4B, the first color scheme 918 and the second color scheme 922 have different widths W13-1, W14-1. Specifically, the width W13-1 is greater than the width W14-1. Alternatively, the width W13-1 may be same as the width W14-1.

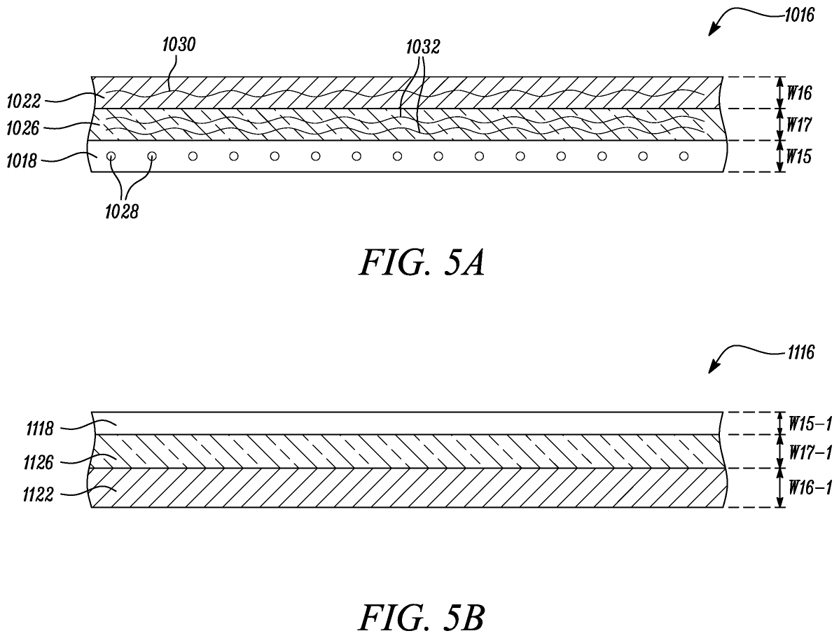

FIG. 5A illustrates a partial schematic front view of an elastic strap 1016, according to yet another embodiment of the present disclosure. The elastic strap 1016 may be used with the respirator 100, 300, 500 (see FIGS. 1A, 2A, and 3A, respectively), without any limitation thereto. The elastic strap 1016 may be substantially similar to the elastic strap 116 of FIGS. 1A and 1B, in terms of material composition and functionality. The elastic strap 1016 includes at least one first color scheme 1018 and at least one second color scheme 1022. The first color scheme 1018 forms a lowermost color scheme of the elastic strap 1016 and the second color scheme 1022 forms a topmost color scheme of the elastic strap 1016. Further, in the illustrated embodiment of FIG. 5A, the elastic strap 1016 includes at least one third color scheme 1026 visibly different from each of the at least one first color scheme 1018 and the at least one second color scheme 1022. The third color scheme 1026 may add an additional overt feature to allow easy identification of counterfeit harnesses. For the sake of identification, the third color scheme is shown with a hatching that is different from the hatching of the first color scheme(s) throughout the embodiments of this disclosure.

In the illustrated embodiment of FIG. 5A, the at least one third color scheme 1026 includes a single third color scheme. Further, the third color scheme 1026 is disposed between the at least one first color scheme 1018 and the at least one second color scheme 1022. Furthermore, the first color scheme 1018 includes a width W15, the second color scheme 1022 includes a width W16, and the third color scheme 1026 includes a width W17. In the illustrated embodiment of FIG. 5A, each of the first color scheme 1018, the second color scheme 1022, and the third color scheme 1026 has a same width W15, W16, W17. In another embodiment, each of the first color scheme 1018, the second color scheme 1022, and the third color scheme 1026 may have different width W15, W16, W17. Alternatively, the width W17 may be similar to any one of the widths W15, W16.

In an example, the first color scheme 1018 may be blue in color. Alternatively, the first color scheme 1018 may have any other color. Further, in an example, the second color scheme 1022 may be white in color. Alternatively, the second color scheme 1022 may have any other color that is visibly different from the color of the first color scheme 1018. Moreover, in an example, the third color scheme 1026 may be red in color. Alternatively, the third color scheme 1026 may have any other color that is visibly different from the colors of the first and second color schemes 1018, 1022.

In some embodiments, each of the first color scheme 1018, the second color scheme 1022, and the third color scheme 1026 have different patterns 1028, 1030, 1032. It should be noted that the patterns 1028, 1030, 1032 defined on the first color scheme 1018, the second color scheme 1022, and the third color scheme 1026 may include any of a plurality of raised horizontal lines, a plurality of horizontal lines, a plurality of vertical lines, a plurality of inclined lines, a plurality of circular or polygonal shapes, a single wave shaped pattern, multiple wave shaped patterns, and the like, without any limitation thereto. Further, the patterns 1028, 1030, 1032 may be defined by continuous lines or discontinuous lines. Furthermore, the patterns 1028, 1030, 1032 may include a raised profile. In the illustrated embodiment of FIG. 5A, the pattern 1028 includes the plurality of circular shapes, the pattern 1030 includes the single wave shaped pattern, and the pattern 1032 includes a pair of wave shaped patterns formed thereon. Alternatively, each of the first color scheme 1018, the second color scheme 1022, and the third color scheme 1026 may have a same pattern. In some examples, the first color scheme 1018 and the second color scheme 1022 may have same patterns that may be different from the pattern of the third color scheme 1026. Alternatively, the pattern of the third color scheme 1026 may be similar to the pattern of any one of the first and second color schemes 1018, 1022.

FIG. 5B illustrates a partial schematic front view of an elastic strap 1116, according to yet another embodiment of the present disclosure. The elastic strap 1116 may be used with the respirators 100, 300, 500 (see FIGS. 1A, 2A, and 3A, respectively). The elastic strap 1116 may be substantially similar to the elastic strap 116 of FIGS. 1A and 1B, in terms of material composition and functionality. In the illustrated embodiment of FIG. 5B, the elastic strap 1116 includes a third color scheme 1126 disposed between a first color scheme 1118 and a second color scheme 1122. The first color scheme 1118 forms a topmost color scheme of the elastic strap 1116 and the second color scheme 1122 forms a lowermost color scheme of the elastic strap 1016. In the illustrated embodiment of FIG. 5B, the first color scheme 1118, the second color scheme 1122, and the third color scheme 1126 have different widths W15-1, W16-1, W17-1. In another embodiment, the first color scheme 1118, the second color scheme 1122, and the third color scheme 1126 may have the same width W15-1, W16-1, W17-1. Alternatively, the width W17-1 may be similar to any one of the widths W15-1, W16-1. It should be noted that details related to patterns and colors of the elastic strap 1016 as explained with reference to FIG. 5A is equally applicable to the elastic strap 1116 of FIG. 5B.

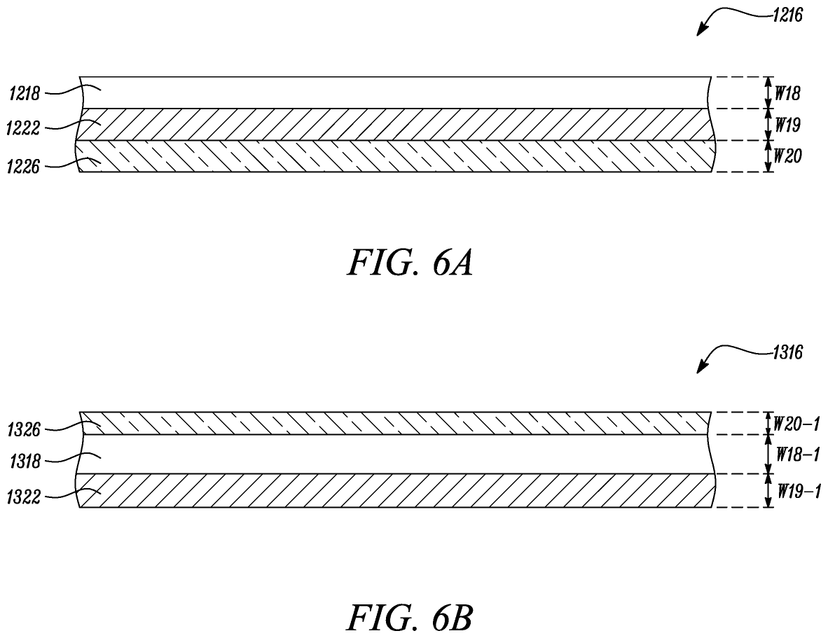

FIG. 6A illustrates a partial schematic front view of an elastic strap 1216, according to yet another embodiment of the present disclosure. The elastic strap 1216 may be used with the respirators 100, 300, 500 (see FIGS. 1A, 2A, and 3A, respectively). The elastic strap 1216 may be substantially similar to the elastic strap 116 of FIGS. 1A and 1B, in terms of material composition and functionality. However, in the illustrated embodiment of FIG. 6A, the elastic strap 1216 includes a third color scheme 1226 disposed adjacent to any one of a first color scheme 1218 and a second color scheme 1222. Specifically, the third color scheme 1226 disposed adjacent to the second color scheme 1222. The third color scheme 1226 forms a lowermost color scheme of the elastic strap 1216, the first color scheme 1218 forms a topmost color scheme of the elastic strap 1216, and the third color scheme 1224 is disposed between the first and third color schemes 1218, 1226. In the illustrated embodiment of FIG. 6A, the first color scheme 1218, the second color scheme 1222, and the third color scheme 1226 have the same width W18, W19, W20. In another embodiment, the first color scheme 1218, the second color scheme 1222, and the third color scheme 1226 may have different widths W18, W19, W20. Alternatively, the width W20 may be similar to any one of the widths W18, W19. It should be noted that details related to patterns and colors of the elastic strap 1016 as explained with reference to FIG. 5A is equally applicable to the elastic strap 1216 of FIG. 6A.

FIG. 6B illustrates a partial schematic front view of an elastic strap 1316, according to yet another embodiment of the present disclosure. The elastic strap 1316 may be used with the respirators 100, 300, 500 (see FIGS. 1A, 2A, and 3A, respectively). The elastic strap 1316 may be substantially similar to the elastic strap 116 of FIGS. 1A and 1B, in terms of material composition and functionality. However, in the illustrated embodiment of FIG. 6B, the elastic strap 1316 includes a third color scheme 1326 disposed adjacent to any one of a first color scheme 1318 and a second color scheme 1322. Specifically, the third color scheme 1326 disposed adjacent to the first color scheme 1318. The third color scheme 1326 forms a topmost color scheme of the elastic strap 1216, the second color scheme 1322 forms a lowermost layer of the elastic strap 1216, and the first color scheme 1318 is disposed between the second and third color schemes 1322, 1226. In the illustrated embodiment of FIG. 6B, the first color scheme 1318, the second color scheme 1322, and the third color scheme 1326 have different widths W18-1, W19-1, W20-1. In another embodiment, the first color scheme 1318, the second color scheme 1322, and the third color scheme 1326 may have the same width W18-1, W19-1, W20-1. Alternatively, the width W20-1 may be similar to any one of the widths W18-1, W19-1. It should be noted that details related to patterns and colors of the elastic strap 1016 as explained with reference to FIG. 5A is equally applicable to the elastic strap 1316 of FIG. 6B.

Referring now to FIGS. 1A to 6B, the elastic straps 116, 216, 316, 416, 516, 616, 716, 816, 916, 1016, 1116, 1216, 1316 may include anti-counterfeiting features that may allow users to easily identify counterfeit harnesses from genuine harnesses. Further, the elastic straps 116, 216, 316, 416, 516, 616, 716, 816, 916, 1016, 1116, 1216, 1316 may include overt and covert features that may allow users to easily identify counterfeit harnesses from genuine harnesses by a simple visual inspection. Further, color compounds used to manufacture the elastic straps 116, 216, 316, 416, 516, 616, 716, 816, 916, 1016, 1116, 1216, 1316 may be ingenious and may be easily detected by lab equipment. Thus, such color compounds may also be used to identify counterfeit harnesses.

Further, the elastic straps 116, 216, 316, 416, 516, 616, 716, 816, 916, 1016, 1116, 1216, 1316 described herein may be disposable and recyclable. Thus, the elastic straps 116, 216, 316, 416, 516, 616, 716, 816, 916, 1016, 1116, 1216, 1316 may be environment friendly. Furthermore, the elastic straps 116, 216, 316, 416, 516, 616, 716, 816, 916, 1016, 1116, 1216, 1316 may include different color combinations that may further reduce counterfeiting of the elastic straps 116, 216, 316, 416, 516, 616, 716, 816, 916, 1016, 1116, 1216, 1316. Moreover, the elastic straps 116, 216, 316, 416, 516, 616, 716, 816, 916, 1016, 1116, 1216, 1316 as described herein may reduce vulnerability of supply chain issues and may also prevent loss of sale revenue, product liability, and efforts spent in litigation of counterfeit harnesses. In some examples, the elastic straps 116, 216, 316, 416, 516, 616, 716, 816, 916, 1016, 1116, 1216, 1316 disclosed herein may be economical to manufacture as compared to conventional elastic straps.

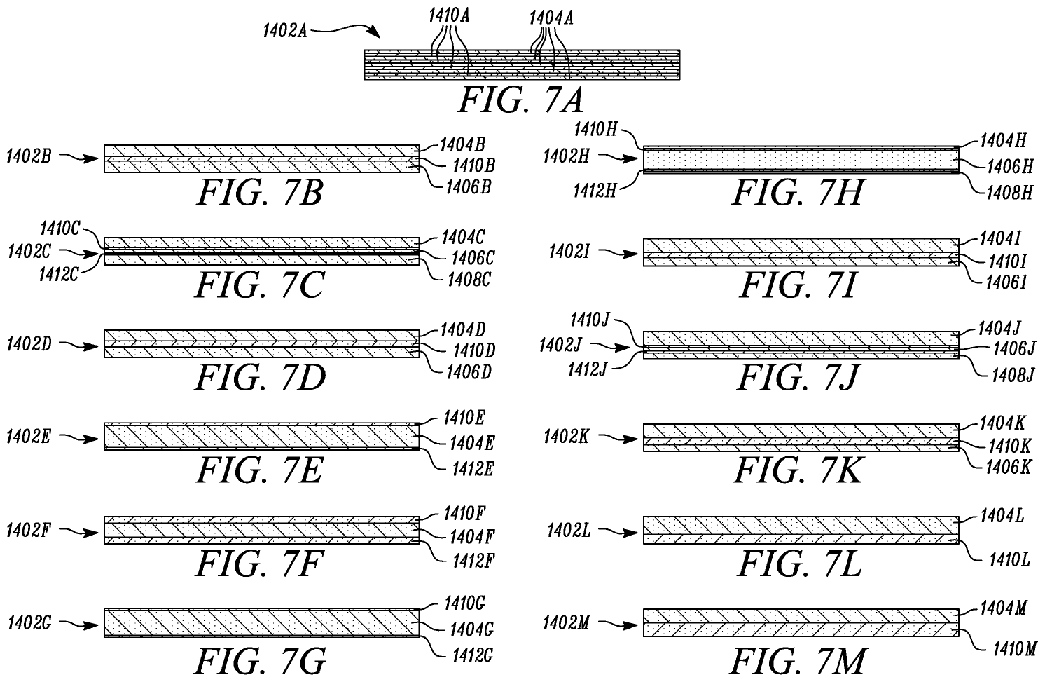

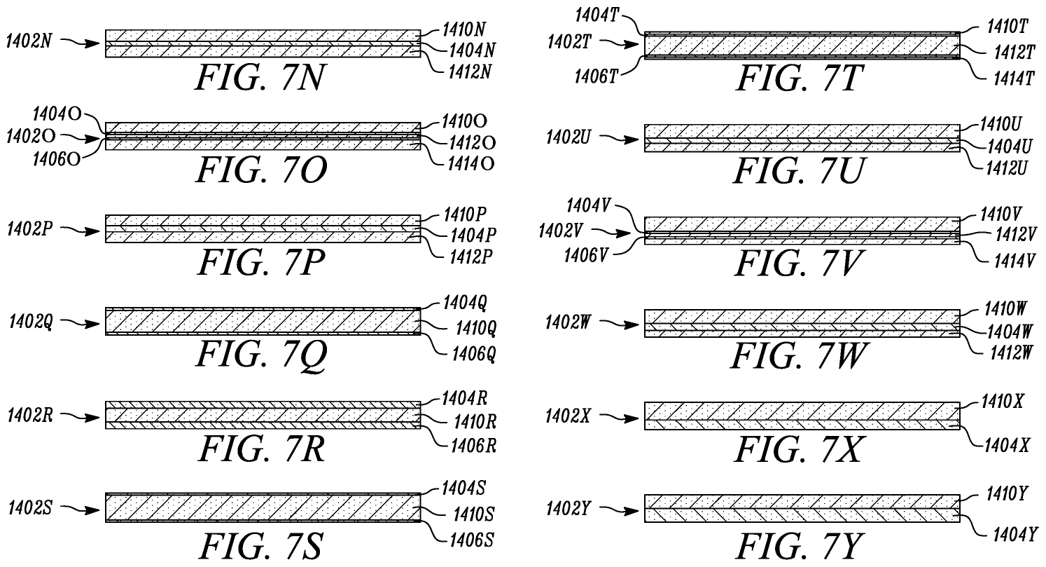

FIGS. 7A to 7Y show partial schematic front views of elastic straps 1402A, 1402B, 1402C, 1402D, 1402E, 1402F, 1402G, 1402H, 1402I, 1402J, 1402K, 1402L, 1402M, 1402N, 1402O, 1402P, 1402Q, 1402R, 1402S, 1402T, 1402U, 1402V, 1402X, 1402Y that may be used with the respirators 100, 300, 500 of FIGS. 1A, 2A, and 3A, respectively, in accordance with various embodiments of the present disclosure. Each elastic strap 1402A, 1402B, 1402C, 1402D, 1402E, 1402F, 1402G, 1402H, 1402I, 1402J, 1402K, 1402L, 1402M, 1402N, 1402O, 1402P, 1402Q, 1402R, 1402S, 1402T, 1402U, 1402V, 1402X, 1402Y is made of a netting material herein.

Referring now to FIG. 7A, the elastic strap 1402A includes alternating layers of first color schemes 1404A and second color schemes 1410A. Referring now to FIG. 7B, the elastic strap 1402B includes a pair of first color schemes 1404B, 1406B and a second color scheme 1410B disposed between the pair of first color schemes 1404B, 1406B. Further, a width of the second color scheme 1410B is substantially lesser than a width of each first color scheme 1404B, 1406B. Referring now to FIG. 7C, the elastic strap 1402C includes three first color schemes 1404C, 1406C, 1408C and two second color schemes 1410C, 1412C. The second color scheme 1410C is disposed between the first color schemes 1404C, 1406C and the second color scheme 1412C is disposed between the first color schemes 1406C, 1408C. Further, a width of the first color scheme 1406C is substantially lesser than a width of each first color scheme 1404C, 1408C. Moreover, a width of each second color scheme 1410C, 1412C is lesser than the width of each first color scheme 1404C, 1406C, 1408C.

Referring now to FIG. 7D, the elastic strap 1402D includes a pair of first color schemes 1404D, 1406D and a second color scheme 1410D disposed between the pair of first color schemes 1404D, 1406D. Further, a width of the second color scheme 1410D is lesser than a width of each first color scheme 1404D, 1406D. However, the width of the second color scheme 1410D is greater than the width of the second color scheme 1410B of FIG. 7B.

Referring now to FIG. 7E, the elastic strap 1402E includes a pair of second color schemes 1410E, 1412E and a first color scheme 1404E disposed between the pair of second color schemes 1410E, 1412E. Further, a width of each second color scheme 1410E, 1412E is lesser than a width of the first color scheme 1404E. Referring now to FIG. 7F, the elastic strap 1402F includes a pair of second color schemes 1410F, 1412F and a first color scheme 1404F disposed between the pair of second color schemes 1410F, 1412F. Further, a width of each second color scheme 1410F, 1412F is substantially lesser than a width of the first color scheme 1404F. However, the width of each second color scheme 1410F, 1412F is greater than the width of each second color scheme 1410E, 1412E of FIG. 7E. Referring now to FIG. 7G, the elastic strap 1402G includes a pair of second color schemes 1410G, 1412G and a first color scheme 1404G disposed between the pair of second color schemes 1410G, 1412G. Further, a width of each second color scheme 1410G, 1412G is substantially lesser than a width of the first color scheme 1404G. However, the width of each second color scheme 1410G, 1412G is lesser than the width of each second color scheme 1410E, 1412E of FIG. 7E and each second color scheme 1410F, 1412F of FIG. 7F.

Referring now to FIG. 7H, the elastic strap 1402H includes three first color schemes 1404H, 1406H, 1408H and two second color schemes 1410H, 1412H. Further, the second color scheme 1410H is disposed between the first color schemes 1404H, 1406H and the second color scheme 1412H is disposed between the first color schemes 1406H, 1408H. Furthermore, a width of the first color scheme 1406H is greater than a width of each first color scheme 1404H, 1408H. Referring now to FIG. 7I, the elastic strap 1402I includes a pair of first color schemes 1404I, 1406I and a second color scheme 1410I disposed between the pair of first color schemes 1404I, 1406I. Further, a width of the second color scheme 1410I is substantially lesser than a width of the first color scheme 1404I. Furthermore, the width of the first color scheme 1404I is greater than a width of the first color scheme 1406I.

Referring now to FIG. 7J, the elastic strap 1402J includes three first color schemes 1404J, 1406J, 1408J and two second color schemes 1410J, 1412J. Further, the second color scheme 1410J is disposed between the first color schemes 1404J, 1406J and the second color scheme 1412J is disposed between the first color schemes 1406J, 1408J. Furthermore, a width of the first color scheme 1404J is greater than a width of each first color scheme 1406J, 1408J and each second color scheme 1410J, 1412J. Referring now to FIG. 7K, the elastic strap 1402K includes a pair of first color schemes 1404K, 1406K and a second color scheme 1410K disposed between the pair of first color schemes 1404K, 1406K. Further, a width of the first color scheme 1404K is greater than a width of the first color scheme 1406K and a width of the second color scheme 1410K. Moreover, the width of the second color scheme 1410K is greater than the width of the second color scheme 1410I of FIG. 7I.

Referring now to FIG. 7L, the elastic strap 1402L includes one first color scheme 1404L and one second color scheme 1410L. A width of the second color scheme 1410L is lesser than a width of the first color scheme 1404L. Referring now to FIG. 7M, the elastic strap 1402M includes one first color scheme 1404M and one second color scheme 1410M. A width of the second color scheme 1410M is substantially equal to a width of the first color scheme 1404M.

Referring now to FIG. 7N, the elastic strap 1402N includes a pair of second color schemes 1410N, 1412N and a first color scheme 1404N disposed between the pair of second color schemes 1410N, 1412N. Further, a width of the first color scheme 1404N is substantially lesser than a width of each second color scheme 1410N, 1412N. Referring now to FIG. 7O, the elastic strap 1402O includes three second color schemes 1410O, 1412O, 1414O and two first color schemes 1404O, 1406O. The first color scheme 1404O is disposed between the second color schemes 1410O, 1412O and the first color scheme 1406O is disposed between the second color schemes 1412O, 1414O. Further, a width of the second color scheme 1412O is substantially lesser than a width of each first color scheme 1410O, 1414O. Moreover, a width of each first color scheme 1404O, 1406O is lesser than the width of each second color scheme 1410O, 1414O.

Referring now to FIG. 7P, the elastic strap 1402P includes a pair of second color schemes 1410P, 1412P and a first color scheme 1404P disposed between the pair of second color schemes 1410P, 1412P. Further, a width of the first color scheme 1404P is lesser than a width of each second color scheme 1410P, 1412P. However, the width of the first color scheme 1410P, 1412P is greater than the width of the first color scheme 1404N of FIG. 7N.

Referring now to FIG. 7Q, the elastic strap 1402Q includes a pair of first color schemes and a second color scheme 1410Q disposed between the pair of first color schemes 1404Q, 1406Q. Further, a width of each first color scheme 1404Q, 1406Q is lesser than a width of the second color scheme 1410Q. Referring now to FIG. 7R, the elastic strap 1402R includes a pair of first color schemes 1404R, 1406R and a second color scheme 1410R disposed between the pair of first color schemes 1404R, 1406R. Further, a width of each first color scheme 1404R, 1406R is substantially lesser than a width of the second color scheme 1410R. However, the width of each first color scheme 1404R, 1406R is greater than the width of each first color scheme 1404Q, 1406Q of FIG. 7Q. Referring now to FIG. 7S, the elastic strap 1402S includes a pair of first color schemes 1404S, 1406S and a second color scheme 1410S disposed between the pair of first color schemes 1404S, 1406S. Further, a width of each first color scheme 1404S, 1406S is substantially lesser than a width of the second color scheme 1410S. However, the width of each first color scheme 1404S, 1406S is lesser than the width of each first color scheme 1404Q, 1406Q of FIG. 7Q and each first color scheme 1404R, 1406R of FIG. 7R.

Referring now to FIG. 7T, the elastic strap 1402T includes three second color schemes 1410T, 1412T, 1414T and two first color schemes 1404T, 1406T. Further, the first color scheme 1404T is disposed between the second color schemes 1410T, 1412T and the first color scheme 1406T is disposed between the second color schemes 1412T, 1414T. Furthermore, a width of the second color scheme 1412T is greater than a width of each second color scheme 1410T, 1414T. Referring now to FIG. 7U, the elastic strap 1402U includes a pair of second color schemes 1410U, 1412U and a first color scheme 1404U disposed between the pair of second color schemes 1410U, 1412U. Further, a width of the first color scheme 1404U is substantially lesser than a width of the second color scheme 1410U. Furthermore, the width of the second color scheme 1410U is greater than a width of the second color scheme 1412U.

Referring now to FIG. 7V, the elastic strap 1402V includes three second color schemes 1410V, 1412V, 1408V and two first color schemes 1404V, 1406V. Further, the first color scheme 1404V is disposed between the second color schemes 1410V, 1412V and the first color scheme 1406V is disposed between the second color schemes 1412V, 1414V. Furthermore, a width of the second color scheme 1410V is greater than a width of each second color scheme 1412V, 1414V and each first color scheme 1404V, 1406V. Referring now to FIG. 7W, the elastic strap 1402W includes a pair of second color schemes 1410W, 1412W and a first color scheme 1404W disposed between the pair of second color schemes 1410W, 1412W. Further, a width of the second color scheme 1410W is greater than a width of the second color scheme 1412W and the first color scheme 1404W. Moreover, the width of the first color scheme 1404W is greater than the width of the first color scheme 1404U of FIG. 7U.

Referring now to FIG. 7X, the elastic strap 1402X includes one second color scheme 1410X and one first color scheme 1404X. A width of the first color scheme 1404X is lesser than a width of the second color scheme 1410X. Referring now to FIG. 7Y, the elastic strap 1402Y includes one second color scheme 1410Y and one first color scheme 1404Y. A width of the first color scheme 1404Y is substantially equal to a width of the second color scheme 1410Y.

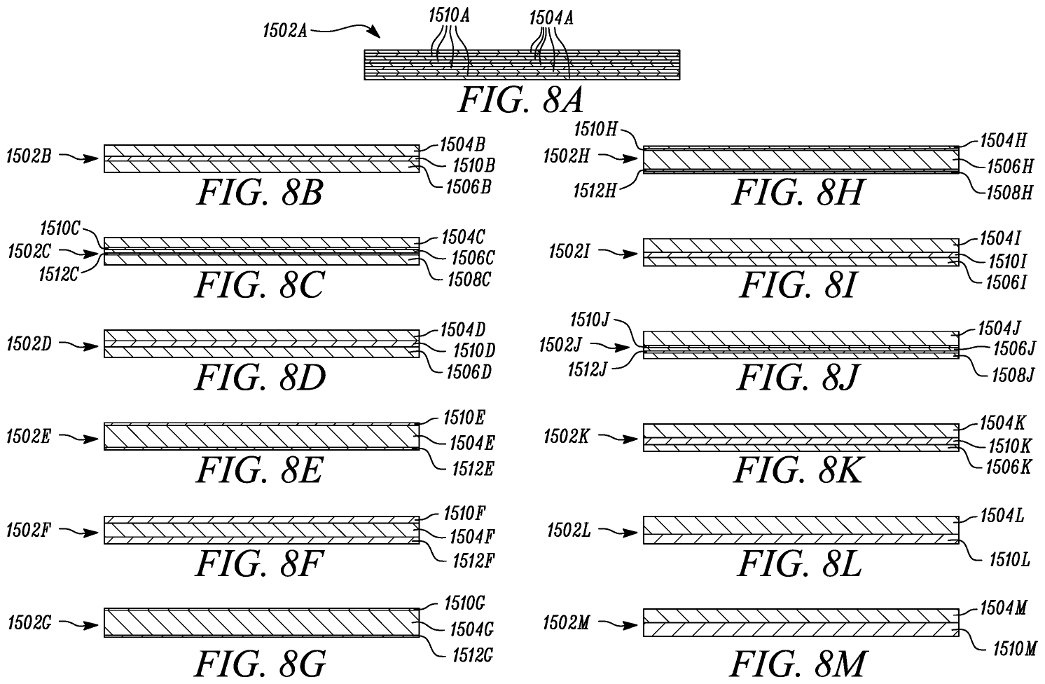

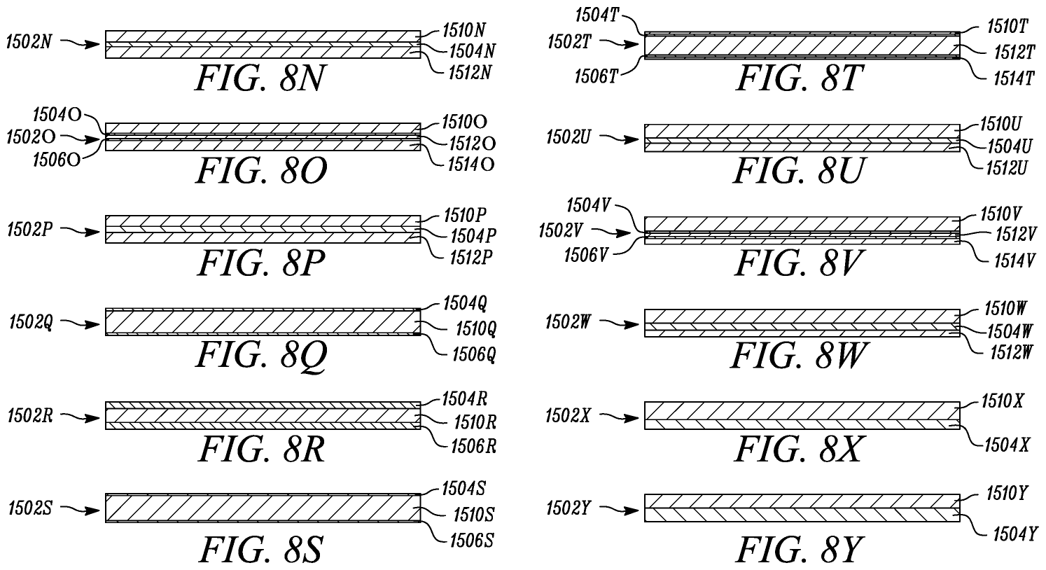

FIGS. 8A to 8Y show partial schematic front views of elastic straps 1502A, 1502B, 1502C, 1502D, 1502E, 1502F, 1502G, 1502H, 1502I, 1502J, 1502K, 1502L, 1502M, 1502N, 1502O, 1502P, 1502Q, 1502R, 1502S, 1502T, 1502U, 1502V, 1502X, 1502Y that may be used with the respirators 100, 300, 500 of FIGS. 1A, 2A, and 3A, respectively, in accordance with various embodiments of the present disclosure. Each elastic strap 1502A, 1502B, 1502C, 1502D, 1502E, 1502F, 1502G, 1502H, 1502I, 1502J, 1502K, 1502L, 1502M, 1502N, 1502O, 1502P, 1502Q, 1502R, 1502S, 1502T, 1502U, 1502V, 1502X, 1502Y is made of a solid material herein.

Referring now to FIG. 8A, the elastic strap 1502A includes alternating layers of first color schemes 1504A and second color schemes 1510A. Referring now to FIG. 8B, the elastic strap 1502B includes a pair of first color schemes 1504B, 1506B and a second color scheme 1510B disposed between the pair of first color schemes 1504B, 1506B. Further, a width of the second color scheme 1510B is substantially lesser than a width of each first color scheme 1504B, 1506B. Referring now to FIG. 8C, the elastic strap 1502C includes three first color schemes 1504C, 1506C, 1508C and two second color schemes 1510C, 1512C. The second color scheme 1510C is disposed between the first color schemes 1504C, 1506C and the second color scheme 1512C is disposed between the first color schemes 1506C, 1508C. Further, a width of the first color scheme 1506C is substantially lesser than a width of each first color scheme 1504C, 1508C. Moreover, a width of each second color scheme 1510C, 1512C is substantially lesser than the width of each first color scheme 1504C, 1506C, 1508C.

Referring now to FIG. 8D, the elastic strap 1502D includes a pair of first color schemes 1504D, 1506D and a second color scheme 1510D disposed between the pair of first color schemes 1504D, 1506D. Further, a width of the second color scheme 1510D is lesser than a width of each first color scheme 1504D, 1506D. However, the width of the second color scheme 1510D is greater than the width of the second color scheme 1510B of FIG. 8B.

Referring now to FIG. 8E, the elastic strap 1502E includes a pair of second color schemes 1510E, 1512E and a first color scheme 1504E disposed between the pair of second color schemes 1510E, 1512E. Further, a width of each second color scheme 1510E, 1512E is lesser than a width of the first color scheme 1504E. Referring now to FIG. 8F, the elastic strap 1502F includes a pair of second color schemes 1510F, 1512F and a first color scheme 1504F disposed between the pair of second color schemes 1510F, 1512F. Further, a width of each second color scheme 1510F, 1512F is substantially lesser than a width of the first color scheme 1504F. However, the width of each second color scheme 1510F, 1512F is greater than the width of each second color scheme 1510E, 1512E of FIG. 8E. Referring now to FIG. 8G, the elastic strap 1502G includes a pair of second color schemes 1510G, 1512G and a first color scheme 1504G disposed between the pair of second color schemes 1510G, 1512G. Further, a width of each second color scheme 1510G, 1512G is substantially lesser than a width of the first color scheme 1504G. However, the width of each second color scheme 1510G, 1512G is lesser than the width of each second color scheme 1510E, 1512E of FIG. 8E and each second color scheme 1510F, 1512F of FIG. 8F.

Referring now to FIG. 8H, the elastic strap 1502H includes three first color schemes 1504H, 1506H, 1508H and two second color schemes 1510H, 1512H. Further, the second color scheme 1510H is disposed between the first color schemes 1504H, 1506H and the second color scheme 1512H is disposed between the first color schemes 1506H, 1508H. Furthermore, a width of the first color scheme 1506H is greater than a width of each first color scheme 1504H, 1506H. Referring now to FIG. 8I, the elastic strap 1502I includes a pair of first color schemes 1504I, 1506I and a second color scheme 1510I disposed between the pair of first color schemes 1504I, 1506I. Further, a width of the second color scheme 1510I is substantially lesser than a width of the first color scheme 1504I. Furthermore, the width of the first color scheme 1504I is greater than a width of the first color scheme 1506I.

Referring now to FIG. 8J, the elastic strap 1502J includes three first color schemes 1504J, 1506J, 1508J and two second color schemes 1510J, 1512J. Further, the second color scheme 1510J is disposed between the first color schemes 1504J, 1506J and the second color scheme 1512J is disposed between the first color schemes 1506J, 1508J. Furthermore, a width of the first color scheme 1504J is greater than a width of each first color scheme 1506J, 1508J and each second color scheme 1510J, 1512J. Referring now to FIG. 8K, the elastic strap 1502K includes a pair of first color schemes 1504K, 1506K and a second color scheme 1510K disposed between the pair of first color schemes 1504K, 1506K. Further, a width of the first color scheme 1504K is greater than a width of the first color scheme 1506K and a width of the second color scheme 1510K. Moreover, the width of the second color scheme 1510K is greater than the width of the second color scheme 1510I of FIG. 8I.

Referring now to FIG. 8L, the elastic strap 1502L includes one first color scheme 1504L and one second color scheme 1510L. A width of the second color scheme 1510L is lesser than a width of the first color scheme 1504L. Referring now to FIG. 8M, the elastic strap 1502M includes one first color scheme 1504M and one second color scheme 1510M. A width of the second color scheme 1510M is substantially equal to a width of the first color scheme 1504M.

Referring now to FIG. 8N, the elastic strap 1502N includes a pair of second color schemes 1510N, 1512N and a first color scheme 1504N disposed between the pair of second color schemes 1510N, 1512N. Further, a width of the first color scheme 1504N is substantially lesser than a width of each second color scheme 1510N, 1512N. Referring now to FIG. 8O, the elastic strap 1502O includes three second color schemes 1510O, 1512O, 1514O and two first color schemes 1504O, 1506O. The first color scheme 1504O is disposed between the second color schemes 1510O, 1512O and the first color scheme 1506O is disposed between the second color schemes 1512O, 1514O. Further, a width of the second color scheme 1512O is substantially lesser than a width of each first color scheme 1510O, 1514O. Moreover, a width of each first color scheme 1504O, 1506O is substantially lesser than the width of each second color scheme 1510O, 1514O.

Referring now to FIG. 8P, the elastic strap 1502P includes a pair of second color schemes 1510P, 1512P and a first color scheme 1504P disposed between the pair of second color schemes 1510P, 1512P. Further, a width of the first color scheme 1504P is lesser than a width of each second color scheme 1510P, 1512P. However, the width of the first color scheme 1510P, 1512P is greater than the width of the first color scheme 1504N of FIG. 8N.

Referring now to FIG. 8Q, the elastic strap 1502Q includes a pair of first color schemes 1504Q, 1506Q and a second color scheme 1510Q disposed between the pair of first color schemes 1504Q, 1506Q. Further, a width of each first color scheme 1504Q, 1506Q is lesser than a width of the second color scheme 1510Q. Referring now to FIG. 8R, the elastic strap 1502R includes a pair of first color schemes 1504R, 1506R and a second color scheme 1510R disposed between the pair of first color schemes 1504R, 1506R. Further, a width of each first color scheme 1504R, 1506R is substantially lesser than a width of the second color scheme 1510R. However, the width of each first color scheme 1504R, 1506R is greater than the width of each first color scheme 1504Q, 1506Q of FIG. 8Q. Referring now to FIG. 8S, the elastic strap 1502S includes a pair of first color schemes 1504S, 1506S and a second color scheme 1510S disposed between the pair of first color schemes 1504S, 1506S. Further, a width of each first color scheme 1504S, 1506S is substantially lesser than a width of the second color scheme 1510S. However, the width of each first color scheme 1504S, 1506S is lesser than the width of each first color scheme 1504Q, 1506Q of FIG. 8Q and each first color scheme 1504R, 1506R of FIG. 8R.

Referring now to FIG. 8T, the elastic strap 1502T includes three second color schemes 1510T, 1512T, 1514T and two first color schemes 1504T, 1506T. Further, the first color scheme 1504T is disposed between the second color schemes 1510T, 1512T and the first color scheme 1506T is disposed between the second color schemes 1512T, 1514T. Furthermore, a width of the second color scheme 1512T is greater than a width of each second color scheme 1510T, 1514T. Referring now to FIG. 8U, the elastic strap 1502U includes a pair of second color schemes 1510U, 1512U and a first color scheme 1504U disposed between the pair of second color schemes 1510U, 1512U. Further, a width of the first color scheme 1504U is substantially lesser than a width of the second color scheme 1510U. Furthermore, the width of the second color scheme 1510U is greater than a width of the second color scheme 1512U.

Referring now to FIG. 8V, the elastic strap 1502V includes three second color schemes 1510V, 1512V, 1508V and two first color schemes 1504V, 1506V. Further, the first color scheme 1504V is disposed between the second color schemes 1510V, 1512V and the first color scheme 1506V is disposed between the second color schemes 1512V, 1514V. Furthermore, a width of the second color scheme 1510V is greater than a width of each second color scheme 1512V, 1514V and each first color scheme 1504V, 1506V. Referring now to FIG. 8W, the elastic strap 1502W includes a pair of second color schemes 1510W, 1512W and a first color scheme 1504W disposed between the pair of second color schemes 1510W, 1512W. Further, a width of the second color scheme 1510W is greater than a width of the second color scheme 1512W and the first color scheme 1504W. Moreover, the width of the first color scheme 1504W is greater than the width of the first color scheme 1504U of FIG. 8U.

Referring now to FIG. 8X, the elastic strap 1502X includes one second color scheme 1510X and one first color scheme 1504X. A width of the first color scheme 1504X is lesser than a width of the second color scheme 1510X. Referring now to FIG. 8Y, the elastic strap 1502Y includes one second color scheme 1510Y and one first color scheme 1504Y. A width of the first color scheme 1504Y is substantially equal to a width of the second color scheme 1510Y.

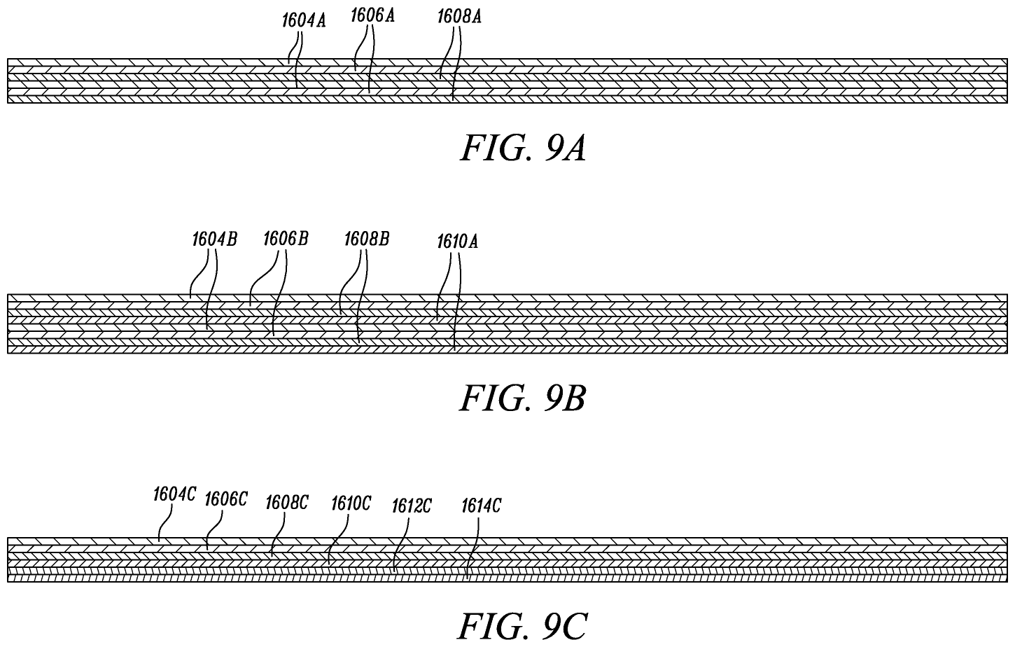

FIGS. 9A to 9C show partial schematic front views of elastic straps 1602A, 1602B, 1602C that may be used with the respirators 100, 300, 500 of FIGS. 1A, 2A, and 3A, respectively, in accordance with various embodiments of the present disclosure. Each elastic strap 1602A, 1602B, 1602C is made of a solid material herein. Alternatively, each elastic strap 1602A, 1602B, 1602C may be made of a netting material.

As shown in FIG. 9A, the elastic strap 1602A includes three different color schemes. Specifically, the elastic strap 1602A includes two first color schemes 1604A, two second color schemes 1606A, and two third color schemes 1608A. It should be noted that the three different color schemes may be arranged in any manner, and may have same or different widths.

As shown in FIG. 9B, the elastic strap 1602B includes four different color schemes. Specifically, the elastic strap 1602B includes a first color scheme 1604B, a second color scheme 1606B, a third color scheme 1608B, and a fourth color scheme 1610B. It should be noted that the four different color schemes may be arranged in any manner, and may have same or different widths.

As shown in FIG. 9C, the elastic strap 1602C includes six different color schemes. Specifically, the elastic strap 1602C includes a first color scheme 1604C, a second color scheme 1606C, a third color scheme 1608C, a fourth color scheme 1610C, a fifth color scheme 1612C, and a sixth color scheme 1614C. It should be noted that the six different color schemes may be arranged in any manner, and may have same or different widths.

It is to be recognized that depending on the example, certain acts or events of any of the methods described herein can be performed in a different sequence, may be added, merged, or left out altogether (e.g., not all described acts or events are necessary for the practice of the method).

Various examples have been described. These and other examples are within the scope of the following claims.

1. A respirator comprising:
a mask body; and
a harness comprising one or more elastic straps, each of the one or more elastic straps being joined to the mask body on opposing sides thereof, each of the one or more elastic straps comprising at least one first color scheme and at least one second color scheme, wherein the at least one first color scheme is visibly different from the at least one second color scheme, and wherein each of the one or more elastic straps comprises at least about 0.5% to about 99.9% of an elastomeric polyolefin by weight.

2. The respirator of claim 1, wherein the elastomeric polyolefin is a metallocene elastomer.

3. The respirator of claim 1, wherein each of the one or more elastic straps further comprises about 0.1% to about 30% of styrene butadiene rubber by weight.

4. The respirator of claim 1, wherein each of the one or more elastic straps further comprises about 0.1% to about 30% of thermal plastic vulcanite by weight.

5. The respirator of claim 1, wherein each of the one or more elastic straps is a one-piece extruded component.

6. The respirator of claim 1, wherein the at least one first color scheme comprises a pair of first color schemes, and wherein the at least one second color scheme is disposed between the pair of first color schemes.

7. The respirator of claim 6, wherein the pair of first color schemes have different widths.

8. The respirator of claim 6, wherein each of the pair of first color schemes has a same width.

9. The respirator of claim 1, wherein the at least one second color scheme comprises a pair of second color schemes, and wherein the at least one first color scheme is disposed between the pair of second color schemes.

10. The respirator of claim 9, wherein the pair of second color schemes have different widths.

11. The respirator of claim 9, wherein each of the pair of second color schemes has a same width.

12. The respirator of claim 1, wherein the at least one first color scheme comprises a plurality of first color schemes, and wherein the at least one second color scheme comprises a plurality of second color schemes alternating with the plurality of first color schemes.

13. The respirator of claim 1, wherein the at least one first color scheme and the at least one second color scheme has a same width.

14. The respirator of claim 1, wherein the at least one first color scheme and the at least one second color scheme have different widths.

15. The respirator of claim 1, wherein each of the one or more elastic straps comprises at least one third color scheme visibly different from each of the at least one first color scheme and the at least one second color scheme.

16. The respirator of claim 15, wherein the at least one third color scheme is disposed between the at least one first color scheme and the at least one second color scheme.

17. The respirator of claim 15, wherein the at least one first color scheme, the at least one second color scheme, and the at least one third color scheme have different widths.

18. The respirator of claim 15, wherein the at least one first color scheme, the at least one second color scheme, and the at least one third color scheme has a same width.

19. The respirator of claim 1, wherein each of the one or more elastic straps has a tensile elongation at break of at least 500%.

20. The respirator of claim 1, wherein each of the one or more elastic straps has a tensile elongation at break of at least 700%.
